(19) United States
(12) Patent Application Publication
(10) Pub. No.: US 2025/0212906 A1
(43) Pub. Date: Jul. 3, 2025

(54) ANALOGUE CHEESE WITH WHEY PROTEIN CREAM

(71) Applicant: General Mills, Inc., Minneapolis, MN (US)

(72) Inventors: Michelle Manderfeld, Plymouth, MN (US); Sara Rosene, New Hope, MN (US); Aaron Wlaschin, St. Paul, MN (US); James Fudge, Champlin, MN (US); Brent Wyrick, Richfield, MN (US); Molley Glidden, Crystal, MN (US)

(21) Appl. No.: 19/086,967

(22) Filed: Mar. 21, 2025

Related U.S. Application Data
(63) Continuation of application No. 17/465,664, filed on Sep. 2, 2021.
(60) Provisional application No. 63/231,565, filed on Aug. 10, 2021.

(51) Int. Cl. A23C 21/06; A23C 20/00

(52) U.S. Cl. CPC A23C 21/06; A23C 20/00; A23C 2250/05

(57) ABSTRACT

An analogue cheese composition can be formulated using a whey protein cream ingredient that has historically been considered a waste byproduct of the whey protein isolate production process. The whey protein cream has been found to found to function as a source of protein in the analogue cheese and provide emulsification properties to the other constituent ingredients incorporated into the analogue cheese composition. Accordingly, in some formulations, the analogue cheese composition may include a comparatively low amount of casein protein, with the whey protein cream functionally compensating for the removed casein protein.

### CROSS-REFERENCE

This application is a continuation of U.S. patent application Ser. No. 17/465,664, filed Sep. 2, 2021, which claims the benefit of U.S. Provisional Patent Application No. 63/231,565, filed Aug. 10, 2021, the entire contents of each of these applications are incorporated herein by reference.

### TECHNICAL FIELD

This disclosure relates to analogue cheese compositions and, more particularly, to analogue cheese compositions formulated using whey protein cream.

### BACKGROUND

Cheese is widely used in frozen foods and readymade conventional meals. For example, cheese is an essential component in frozen pizzas and other cheese-containing hot snacks. The costs associated with natural cheese, seasonal price fluctuation, and storage requirements have prompted the food industry to search for alternatives to natural cheese. Analogue cheese compositions are one solution to the challenges of using natural cheese. Analogue cheese compositions are generally described as compositions that look like natural cheese and have a taste profile similar to natural cheese but in which constituents including milk fat have been partly or completely replaced by other ingredients. Milk fat is typically substituted with vegetable fat to formulate an analogue cheese.

Analogue cheese compositions generally include casein. Casein is a protein naturally found in milk that helps provide the functional characteristics found in the majority of natural cheese varieties. Casein is present in various forms in milk, including rennet casein; caseinates: sodium caseinate, calcium caseinate, potassium caseinate; acid casein; micellar casein; etc. While casein provides desired functional properties in the formulation of analogue cheese compositions, casein can be a challenging ingredient for food manufacturers. Casein is an expensive ingredient used in analogue cheese compositions. Moreover, the available supply of casein is limited. During periods of significant demand increase for cheese-containing products, food manufacturers can experience casein shortages that limit their product analogue cheese compositions.

For these and other reasons, food manufacturers may attempt to reduce the amount of casein used in an analogue cheese formulation. But reducing or replacing a conventional analogue cheese composition ingredient such as casein protein can present many expected or unexpected technical hurdles. Analogue cheese compositions are complex compositions and their properties can be sensitive to the presence of certain ingredients, in functional amounts. For example, casein protein can help provide structure to an analogue cheese composition and also emulsification properties to help emulsify the various constituent ingredients included in the cheese composition. Reducing the amount of an ingredient, such as casein, traditionally used in an analogue cheese composition can cause undesirably change the structure and properties of the cheese.

### SUMMARY

In general, this disclosure is directed to analogue cheese compositions that are formulated using a whey protein cream ingredient. Whey protein cream is typically produced as a co-product of the whey protein isolate manufacturing process. Whey protein cream has a higher fat and lower protein content than whey protein concentrates and whey protein isolates, which can make the ingredient more challenging to use in the commercial food industry. The comparatively high fat level can limit formulation flexibility, particularly when striving to achieve calorie content targets in finished human and/or animal food products. As a result, the properties and uses of whey protein cream have not been recognized or extensively studied in the art space.

Applicant has identified unexpected properties and benefits of utilizing whey protein cream in an analogue cheese composition. The whey protein cream can function as a source of protein for the analogue cheese composition and can help emulsify the food system. As a protein source, the whey protein cream can provide nutritional value for the analogue cheese composition and help build the structure of the cheese. As an emulsifier, the whey protein cream can help emulsify the constituent components of the composition together, forming a homogenous composition. Without wishing to be bound by any particular theory, it is believed the phospholipids naturally present in the whey protein cream help contribute to the emulsification properties of the whey protein cream beneficially employed in the analogue cheese composition.

In some specific formulations, the analogue cheese composition containing the whey protein cream is formulated with a reduced relative amount of casein protein. For example, the analogue cheese composition may be formulated with less than 15 weight percent casein protein, less than 12 weight percent casein protein, less than 3 weight percent casein protein, less than 1 weight percent casein protein, or, in some specific implementations, may be entirely devoid of casein protein. The whey protein cream ingredient incorporated into the analogue cheese composition can substitute for the casein protein partially or fully removed from the analogue cheese composition, as compared to an analogous analogue cheese composition having a greater amount of casein protein and lacking whey protein cream.

Additionally or alternatively, the analogue cheese composition may be formulated with a reduced relative amount of emulsifying salts including, in some embodiments, without any emulsifying salts. In a typical analogue cheese composition, emulsifying salts can function to assist in the hydration of casein protein present in the composition, helping to functionalize the casein protein in the composition. The emulsifying properties provided by the whey protein cream ingredient can partially or fully substitute for the emulsification properties normally provided by emulsifying salts. As result, the amount of emulsifying salt added to the analogue cheese composition may be reduced or eliminated through the use of whey protein cream ingredient.

In one example, a cheese composition is described that includes fat, water, a hydrocolloid, and whey protein cream. The fat ranges from 5 to 40 weight percent of the composition, the water ranges from 15 to 60 weight percent of the composition, the hydrocolloid ranges from 5 to 20 weight percent of the composition, and the whey protein cream forms at least 0.5 weight percent of the composition.

In another example, a cheese composition is described that includes fat, water, hydrocolloid, casein protein, and whey protein cream. The fat ranges from 20 to 30 weight of the composition, the water ranges from 30 to 60 weight percent of the composition, the hydrocolloid ranges from 8 to 17 weight percent of the composition, the casein protein ranges from 1 to 12 weight percent of the composition, and the whey protein cream ranges from 1 to 5 weight percent of the composition.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block flow diagram illustrating an example technique for producing whey protein cream.

FIG. 2 is a chart illustrating oil incorporation times for different analogue cheese samples tested as part of an experiment.

FIG. 3 is a chart illustrating textural firmness measurements for different analogue cheese compositions formulated according to an experiment.

### DETAILED DESCRIPTION

This disclosure generally relates to analogue cheese compositions containing whey protein cream, food products incorporating the analogue cheese composition, and associated methods in which the analogue cheese composition is formulated with whey protein cream (optionally with a relatively reduced amount of casein protein and/or emulsifying salt). The analogue cheese composition may be formulated with a limited amount of casein protein or, in other examples, may not include any added casein protein. Reduced casein protein levels in the analogue cheese composition may deteriorate the functional properties of the analogue cheese composition. In accordance with examples of the present disclosure, whey protein cream can be added to the analogue cheese composition to counteract the reduced performance of the analogue cheese caused by reducing the casein protein loading.

As used herein, the following terms used in the application have the following meanings:

An “analogue cheese” as used herein refers generally to a cheese in which a milk fat and/or a protein source has been substituted with a source that is not native to milk. Cheese analogues are typically categorized as dairy, partial dairy, or nondairy, depending on whether the fat and/or dairy components are from dairy or vegetable sources. They can also be classified as being an imitation cheese or a substitute cheese. Imitation cheese is a substitute for and resembles another cheese but is nutritionally inferior to that cheese. A cheese substitute, on the other hand, resembles another cheese but is not nutritionally inferior to that cheese.

A “dairy cheese” as used herein refers to a natural cheese composition made directly from milk that meets specific United States Department of Agriculture (USDA) standards specified for natural cheese compositions, including ingredients used, manufacturing procedures used, and final nutritional value. For example, the requirements for mozzarella cheese are provided by 21 C.F.R. §§ 1.33.155-133.158.

A “whey protein cream” as used herein refers to a whey product having a minimum of 50 wt % protein (dry basis), a minimum of 10 wt % fat, a maximum of 8 wt % ash, and a maximum of 10 wt % moisture.

“Textual firmness” as used herein means a textual firmness measurement made on a cheese sample having height and diameter of 2 inches each using a texture analyzer configured with an 8¼″ stainless steel ball probe, where the test is conducted at a speed of 1.00 mm/see, the target mode of the test is distance, the distance set point is 4.00 mm with a hold time of 20.00 seconds, and the test has an auto trigger of force with a trigger force set point of 4.00 g.

“L.D. Schreiber melt test” as used herein refers to the common meltability test for process and analog cheese. An oven is preheated to 450° F. A wedge of cheese is sliced to a thickness of about 0.5 inches. A disc-shaped piece of cheese is cut from the wedge using a metal circular cutter (39.2 mm diameter, 7.3 mm deep). The weight of the disc of cheese should be between 8.5 and 8.9 grams (trim disc with circular cutter if needed). The disc of cheese is then placed in the center of a 15 mmx 100 mm glass Petri dish. Then the cover of the Petri dish is placed over the Petri dish and the dish is placed in the oven for exactly 5 minutes. The Petri dish is then removed from the oven. The procedure for determining a Melt Test Value involves measuring the “spread” of the cheese after it has been baked. Two perpendicular measurements of spread are taken and averaged in millimeters and converted into a Melt Test Value according to the following conversions:

| | Melt | | Melt |
|---|---|---|---|
| | Test | | Test |
| mm | Value | mm | Value |
| 40 | 1 | 43.1 | 1.5 |
| 46 | 2 | 49.6 | 2.5 |
| 53 | 3 | 56.1 | 3.5 |
| 59 | 4 | 62.6 | 4.5 |
| 66 | 5 | 69.1 | 5.5 |
| 72 | 6 | 75.6 | 6.5 |
| 79 | 7 | 88.6 | 7.5 |

In general, analogue cheese compositions are described that may include whey protein cream, fat, water, a hydrocolloid and a variety of other optional additives, such as structure builders, colorants, flavorants, preservatives, etc. In some implementations, the analogue cheese composition also includes a protein source, such as casein protein. The amount of casein protein added to the analogue cheese, if any, may be relatively reduced to provide a low casein analogue cheese composition. The whey protein cream used in the analogue cheese composition may substitute for and/or otherwise help compensate for the reduced amount of casein protein present in the composition. The described analogue cheese compositions with whey protein cream are non-natural cheese compositions (e.g., imitation cheese compositions) that include a relatively reduced amount of casein protein when compared to otherwise comparable cheese compositions, while providing functional, organoleptic, and/or nutritional properties that are suitable notwithstanding the reduced level of casein protein.

In some examples, the analogue cheese composition with whey protein cream includes one or more emulsifying salts. The emulsifying salts can help functionalize casein protein in the analogue cheese composition to emulsify the hydrophilic and hydrophobic components of the composition to produce a substantially homogenous composition. The amount of emulsifying salt, when used in the analogue cheese composition incorporating whey protein cream, may be relatively reduced compared an otherwise compositionally similar analogue cheese composition not utilizing whey protein cream. The whey protein cream ingredient has been identified to provide properties, allowing the whey protein cream to substitute for and/or otherwise help compensate for a reduction in emulsifying salts that may otherwise be used in the composition.

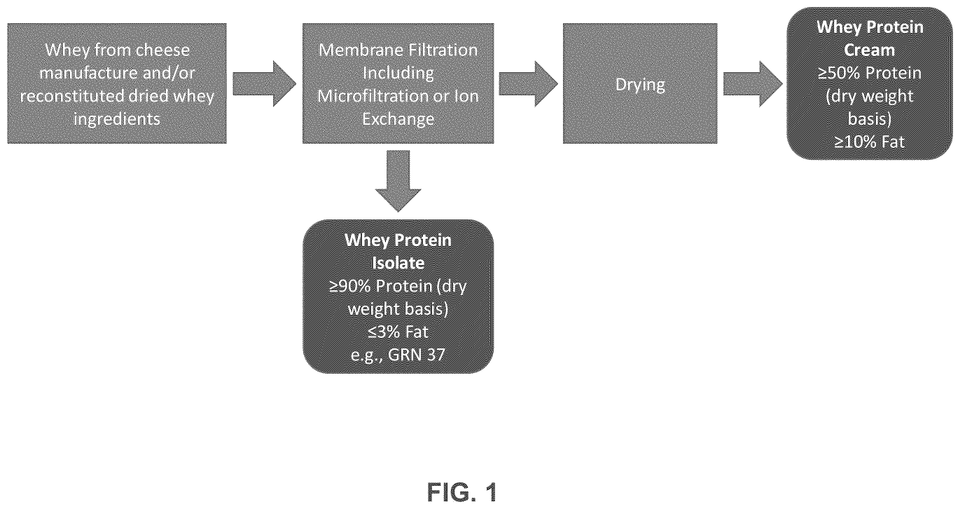

An analogue cheese composition according to disclosure includes whey protein cream. Whey protein cream, also known as whey protein phospholipid concentrate, is a retentate stream of whey protein microfiltration. Whey protein cream can be produced as a coproduct when producing whey protein isolate through the microfiltration or ion exchange of a whey protein concentrate (WPC) stream. FIG. 1 is a simplified block flow diagram illustrating an example technique for producing whey protein cream.

In production, whey protein cream can be produced from the microfiltration or ion exchange of whey protein concentrate. Microfiltration and ion exchange are processes in the dairy industry that separate the majority of whey protein from the other whey protein concentrate constituents (e.g., fat, phospholipids, lactose, minerals). Whey protein cream typically includes at least 50 wt % protein (dry basis), at least 10 weight percent fat, less than 8 wt % ash, and less than 10 wt % moisture. One example standard for characterizing whey protein cream is the American Dairy Products Institute 2015 “Whey Protein Phospholipid Concentrate (WPPC) Standard,” the entire contents of which are incorporated herein by reference.

In various examples, whey protein cream includes at least 10 wt % fat, such as at least 12 wt %, at least 13 wt %, at least 15 wt %, at least 17 wt %, at least 20 wt %, at least 30 wt % or at least 35 wt %. The maximum amount of fat in the whey protein cream in one or more of these examples may be less than 50 wt %, such as less than 40 wt %, less than 35 wt %, less than 30 wt %, less than 25 wt %, less than 20 wt %, less than 18 wt %, less than 17 wt %, less than 16 wt %, less than 15 wt %, less than 14 wt %, or less than 13 wt %.

In various examples, whey protein cream includes greater than 50 wt % protein, such as greater than 52 wt %, greater than 54 wt %, greater than 60 wt %, greater than 62 wt %, greater than 65 wt %, or greater than 68 wt %. The maximum amount of protein in the whey cream in one or more of these examples may be less than 82 wt %, such as less than 80 wt %, less than 75 wt %, less than 70 wt %, less than 65 wt %, less than 60 wt %, less than 55 wt %, or less than 53 wt %.

In various examples, whey protein cream includes greater than 1 wt % lactose, such as greater than 2 wt %, greater than 3 wt %, greater than 5 wt %, greater than 8 wt %, or greater than 10 wt %. The maximum amount of lactose in the whey cream in one or more of these examples may be less than 15 wt %, such as less than 10 wt %, less than 8 wt %, less than 6 wt %, less than 5 wt %, less than 4 wt %, less than 3 wt %, less than 2 wt %, or less than 1 wt %.

In general, the whey protein cream includes less than 10 wt % ash, such as less than 8 wt %, less than 6 wt %, less than 5 wt %, less than 4 wt %, less than 3 wt %, less than 2 wt %, or less than 1 wt %.

The whey protein cream is typically dried to a moisture content less than 10 wt %, such as less than 8 wt %, less than 6 wt %, less than 5 wt %, less than 4 wt %, less than 3 wt %, less than 2 wt %, or less than 1 wt %.

Whey protein cream contains phospholipids naturally found in milk. The most abundant phospholipids may be zwitterionic phospholipids, phosphatidylcholine and phosphatidylethanolamine, and sphingolipid sphingomyelin. These phospholipids are typically at higher concentrations in dried whey protein cream than found in fluid whey.

The amount of whey protein cream incorporated into the analogue cheese composition may vary depending on the specific functional, organoleptic, and/or nutritional properties targeted for the analogue cheese composition. In different formulations, the analogue cheese composition includes at least 0.1 weight percent whey protein cream based on the total weight of the analogue cheese composition, such as at least 0.25 weight percent, at least 0.5 weight percent, at least 0.75 weight percent, at least 1.0 weight percent, at least 1.25 weight percent, at least 1.5 weight percent, at least 2.0 weight percent, at least 2.25 weight percent, at least 2.5 weight percent, at least 2.75 weight percent, at least 3.0 weight percent, at least 3.5 weight percent, at least 4.0 weight percent, at least 4.5 weight percent, at least 5.0 weight percent, at least 6.0 weight percent, at least 7.0 weight percent, at least 8.0 weight percent, at least 9.0 weight percent, at least 10.0 weight percent, at least 12.5 weight percent, at least 15.0 weight percent, or at least 17.5 weight percent.

A maximum amount of whey protein cream used in the analogue cheese composition may be limited (e.g., within a range bounded by any one of the foregoing minimum limits) to an amount less than 35 weight percent based on the total weight of the analogue cheese composition, such as less than 25 weight percent, less than 20 weight percent, less than 15 weight percent, less than 10.0 weight percent, less than 9.0 weight percent, less than 8.0 weight percent, less than 7.0 weight percent, less than 6.0 weight percent, less than 5.0 weight percent, less than 4.5 weight percent, less than 4.0 weight percent, less than 3.5 weight percent, less than 3.0 weight percent, less than 2.5 weight percent, less than 2.0 weight percent, less than 1.0 weight percent, less than 0.75 weight percent, or less than 0.5 weight percent. For example, the amount of whey protein cream used in the analogue cheese composition may range from 0.25 weight percent to 15 weight percent based on the total weight of the analogue cheese composition, such as from 0.5 weight percent to 10 weight percent, from 0.75 weight percent to 8 weight percent, about 1.0 weight percent to about 5.0 weight percent, or from about 2.0 weight percent to about 4.0 weight percent.

In the foregoing discussion of relative amounts of whey protein cream that may be utilized in the analogue cheese composition, it is assumed that the whey protein cream is in dry form (e.g., powder, particulate). If utilizing a liquid whey protein cream, the amount of whey protein cream incorporated into the analogue cheese composition may be proportionally adjusted based on the amount of water present in the whey protein cream.

The analogue cheese composition can include a fat ingredient of a type and in an amount to provide desired functional properties in the resultant cheese. The type and amount of fat can affect properties of the analogue cheese, such as melt, crumble, stretch, firmness, final texture, etc. Fat ingredients are commonly and synonymously referred to as a fat, shortening, or oil. Fat can be either liquid or solid at room temperature, or a combination of liquid and solid at room temperature (e.g., semisolid).

Whey protein cream includes fat and will provide fat to the analogue cheese composition once incorporated therein. One or more supplemental fat ingredients may be added to the analogue cheese composition to increase the fat content of the composition. Fat ingredients (other than whey protein cream) typically used in analogue cheese compositions typically include vegetable fat, dairy fat, and combinations thereof. Dairy fat may be used in analogue cheese compositions that are dairy or partial dairy analogues. In some compositions, however, the analogue cheese is formulated as a nondairy analogue cheese that does not utilize fat extracted or otherwise derived from a dairy source. In these compositions, the fat ingredient may be provided entirely from (e.g., consist essentially of, or consist of) non-diary fat, such as vegetable fat. In other words, substantially all fat added to the analogue cheese composition (which is considered to be separate from the fat included in the whey protein cream) may be non-dairy fat.

Exemplary fat ingredients include all vegetable fats and oils, individual ingredients or blends thereof, fractionated, interesterified, or fully hydrogenated. Examples of such fat ingredients include hydrogenated coconut oil, cottonseed oil, soybean oil, groundnut oil, palm oil, palm kernel oil, corn oil, canola oil, safflower oil and combinations thereof.

In general, a useful amount of fat added to the analogue cheese composition can include an amount that provides suitable properties such as cheese composition flavor, texture, processing, stability, and melting properties. Such an amount can be in a range from about 5 to about 50 weight percent fat based on total weight of the analogue cheese composition, such as from about 5 to about 40 weight percent based on total weight of the analogue cheese composition, from about 10 to about 40 weight percent based on total weight of the analogue cheese composition, about 15 to about 35 weight percent fat based on total weight of the analogue cheese composition, or from about 20 to about 30 weight percent fat based on the total weight of the analogue cheese composition. The fat in the whey protein cream is not included in calculating these foregoing weight percentages of added fat in the analogue cheese composition.

Since whey protein cream includes fat, the amount of fat (other than whey protein cream) introduced into the analogue cheese composition may be proportional to the amount of whey protein cream introduced into the analogue cheese composition. For example, a ratio of the weight of fat added to the analogue cheese composition (not including fat from the whey protein cream) divided by the weight of whey protein cream in the analogue cheese composition may be at least 1.0, such as at least 2.0, at least 3.0, at least 4.0, or at least 5.0, or at least 10.0 For example, the ratio may range from 6.0 to 30.0, such as from 7.0 to 15.0.

The analogue cheese composition can include one or more protein sources, including casein protein. Protein can influence functional, organoleptic, and nutritional properties of a cheese composition. Protein generally forms a three-dimensional network within a cheese composition and can influence melt, stretch, machinability, depositing performance, freeze/thaw stability, bake performance, taste, and color characteristics of a cheese composition. Protein can also influence nutritional characteristics. Proteins that can be used in the analogue cheese composition include dairy proteins like casein protein, non-casein dairy proteins, and non-dairy proteins such as vital wheat gluten protein.

Casein protein is an edible protein that can be found naturally in milk and that is conventionally known to provide many important characteristics in cheese compositions. Casein protein is conventionally understood to be at least in part responsible for certain desired functional and organoleptic properties of a cheese composition. As used herein, the term “casein protein” means casein in all its forms, including rennet casein, acid casein, caseinate derivatives, fresh cheese, and dehydrated cheese. One specific form of casein protein is rennet casein protein.

Rennet casein can be produced by precipitation of pasteurized skim milk. The precipitation can be accomplished with use of an enzyme called rennin, which can be of animal or microbial origin. Methods of producing and isolating rennet casein from skim milk are well known. Precipitated rennet casein is typically washed, pressed, dried, ground, sieved, and blended to provide a homogenous powder containing approximately 80 weight percent casein protein.

The amount of casein protein included in the analogue cheese composition may be set relatively low to limit the amount of casein protein while still providing acceptable functional properties for the resultant analogue cheese. For example, the amount of casein protein included in the analogue cheese composition may be less than 20 weight percent based on the total weight of the analogue cheese composition, such as less than 15 weight percent, less than 12 weight percent, less than 10 weight percent, less than 9.0 weight percent, less than 8.0 weight percent, less than 7.0 weight percent, less than 6.0 weight percent, less than 5.0 weight percent, less than 4.0 weight percent, less than 3.0 weight percent, less than 2.5 weight percent, less than 2.0 weight percent, less than 1.0 weight percent, or less than 0.5 weight percent. Indeed, in one implementation, the analogue cheese composition includes about 0 weight percent casein protein.

More commonly, however, the analogue cheese composition may include at least a minimal amount of casein protein, e.g., to impart structure and functional properties to the analogue cheese. For example, the analogue cheese composition may include at least 0.1 weight percent casein protein based on the total weight of the analogue cheese composition, such as at least 0.25 weight percent, at least 0.5 weight percent, at least 1.0 weight percent, at least 1.5 weight percent, at least 2.0 weight percent, at least 2.5 weight percent weight percent, at least 3.0 weight percent, at least 3.5 weight percent, at least 4.0 weight percent, at least 4.5 weight percent, at least 5.0 weight percent, at least 6.0 weight percent, at least 7.0 weight percent, at least 8.0 weight percent, at least 9.0 weight percent, or at least 10.0 weight percent. Any of these minimum casein protein levels can be combined with any of the aforementioned maximum casein protein levels to provide a target casein protein range for formulating a particular analogue cheese composition.

For example, the analogue cheese composition may include from 0.5 to 15 weight percent casein protein based on the total weight of the analogue cheese composition, such as from 0.5 to 12 weight percent, from 0.5 to 5 weight percent, from 5 to 10 weight percent, from 3 to 9 weight percent, from 4 to 12 weight percent, or from 0.5 to 8 weight percent.

In some implementations, substantially all protein present in the analogue cheese composition (e.g., 98 wt %+, 99 wt %+, or 99.5 wt %) is casein protein and protein from the whey protein cream. In these examples, casein protein and whey protein cream may be incorporated into the analogue cheese composition without adding a third ingredient as a protein source for the cheese composition.

Since whey protein cream includes protein, the amount of casein protein introduced into the analogue cheese composition may be proportional to the amount of whey protein cream introduced into the analogue cheese composition. For example, a ratio of the weight whey protein cream added to the analogue cheese composition divided by the weight of casein protein added to the analogue cheese composition may range from 0.1 to 10, such as from 0.5 to 8, or from 1 to 4.

The analogue cheese composition may or may not include non-casein protein (in addition to or in lieu of casein protein), which includes non-casein dairy protein, non-dairy protein, and combinations thereof. Non-casein dairy protein includes protein naturally found in milk. Exemplary non-casein, dairy protein includes whey protein (e.g., whey protein concentrate or isolate). Suitable non-casein, non-dairy protein includes gluten protein (e.g., vital wheat gluten protein), soy protein, wheat protein, wheat protein isolate, pea protein, faba protein, canola protein, chickpea protein, mung bean protein, potato protein, rice protein, and/or combinations thereof. In certain analogues cheese compositions, non-casein, non-dairy protein can be used to make-up for shortcomings in functional properties of the cheese associated with reducing the amount of casein protein otherwise present in the analogue cheese composition.

In some implementations, the analogue cheese composition is formulated without including any non-casein protein ingredients. In other implementations, the analogue cheese composition includes one or more non-casein protein ingredients, which may be non-casein, non-dairy protein ingredients. When a non-casein protein is included in the analogue cheese composition, the non-casein protein may be used in an amount less than 15 weight percent of the total weight of the analogue cheese composition, such as less than 10 weight percent of the analogue cheese composition, or less than 5 weight percent of the analogue cheese composition.

The analogue cheese composition may include one or more hydrocolloids and/or gelling and/or colloidal proteins. Typical hydrocolloids used in the food production industry are polysaccharides and and/or gelling and/or colloidal proteins that can function to control, for example, the stability, texture, and/or organoleptic properties of a food product. Hydrocolloids that may be usefully employed in the analogue cheese composition include agar, alginate, carrageenan, gelatin, guar gum, locust bean gum, pectin, xanthan gum, starch, and combinations thereof.

In some formulations, the analogue cheese composition includes at least starch as an ingredient used within the ingredient category of hydrocolloids other than guar gum. For example, when the analogue cheese composition is formulated to include one or more hydrocolloids, starch may provide at least 50 weight percent of the one or more hydrocolloids, such as at least 75 weight percent, at least 90 weight percent, or 100 weight percent. In addition to or in lieu of starch, the analogue cheese composition may include one or more hydrocolloids (e.g., gums) other starch.

Starch can also influence one or more of functional properties of the analogue cheese composition. When used, the starch may be pre-gelatinized, non-pregelatinized, modified, or unmodified. In some formulations, the starch incorporated into the analogue cheese composition is a non-pregelatinized, modified starch. As used herein a “modified” starch means that the structure of starch has been modified chemically, thermally, or by other means developed in the future, to alter the viscosity of the starch in water. One example of a non-pregelatinized, modified starch that may be used is a non-pregelatinized, thermally-inhibited starch.

As used herein, the term “non-pregelatinized” modified starch means a starch that is insoluble in cold water and appears birefringent when seen under polarized light with a microscope. Non-pregelatinized, modified starch (also known as cook-up starch) tends to gradually thicken upon heating. During one or more stages of a cheese-making process, non-pregelatinized, modified starch granules can and typically do become gelatinized. Gelatinization is a series of changes that starch undergoes when heated in excess water, which solubilizes the starch and results in increased viscosity and disappearance of birefringence. Also during one or more stages of the cheese-making process, non-pregelatinized, modified starch granules can break down or reduce in size to a certain degree as a result of one or more of heating, mixing, and shearing the granule in a cheese composition. A non-pregelatinized, modified starch that is resistant to such breakdown can tend to provide suitable viscosity characteristics during processing. The resistance to granule breakdown results in a starch granule in the final analogue cheese composition that is relatively larger in size (e.g., larger cross-sectional area) as compared to a starch granule that is not as resistant to such breakdown during processing.

When used, the one or more hydrocolloids may be incorporated into the analogue cheese composition in an amount from 3.0 to 25 weight percent of the analogue cheese composition based on the total weight of the of the analogue cheese composition, such as from 5 to 20 weight percent, from 7 to 15 weight percent, or from 8 to 12 weight percent. When starch is used, the starch can be procured from one or more sources such as corn, potato, sweet potato, wheat, rice, sago, tapioca, sorghum, and other plant sources.

The analogue cheese composition may typically include water. The amount of water included in the analogue cheese composition may range from 25 weight percent to 65 weight percent, based on the total weight of the analogue cheese composition, such as from 30 weight percent to 60 weight percent, from 25 weight percent to 50 weight percent, or from 30 weight percent to 40 weight percent. In some formulations, water constitutes a majority weight percent of the analogue cheese composition (e.g., greater than 50 weight percent of the analogue cheese composition based on the total weight of the analogue cheese composition). In some formulations, water is less than a majority weight percent of the analogue cheese composition (e.g., less than 50 weight percent of the analogue cheese composition based on the total weight of the analogue cheese composition).

The analogue cheese composition may include one or more emulsifying salts. The addition of an emulsifying salt to the analogue cheese composition can be beneficial to hydrate the casein protein, rennet casein, (when used), allowing the casein protein to effectively impart desired functional properties to the analogue cheese composition. For example, an emulsifying salt may detach divalent calcium ions from the cheese matrix and replace them with monovalent sodium ions. This ionic exchange can convert the insoluble calcium paracaseinate into sodium paracaseinate, which is more soluble and functions as an emulsifier and stabilizer in the analogue cheese melt.

Exemplary emulsifying salt include monosodium phosphate, disodium phosphate, dipotassium phosphate, trisodium phosphate, sodium metaphosphate (sodium hexametaphosphate), sodium acid pyrophosphate, tetrasodium pyrophosphate, sodium aluminum phosphate, sodium citrate, potassium citrate, calcium citrate, sodium tartrate, sodium potassium tartrate, and combinations thereof.

When used, a relatively decreased amount of one or more emulsifying salts may be incorporated into the analogue cheese composition incorporating the whey protein cream. The emulsification properties provided by the whey protein cream may substitute for, or other allow a reduction in, the amount of emulsifying salt used in the analogue cheese composition.

When used, the amount of emulsifying salts introduced into the analogue cheese composition may be proportional to the amount of whey protein cream introduced into the analogue cheese composition. For example, a ratio of the weight of emulsifying salts divided by the weight of whey protein cream in the analogue cheese composition may be less than 7, such as less than 5, less than 3, less than 1, less than 0.5, less than 0.25, less than 0.1, less than 0.05, or less than 0.025. For example, the ratio of the weight of emulsifying salts divided by the weight of whey protein cream may range from 0.01 to 3, such as from 0.025 to 1.

The actual weight percentage of emulsifying salts incorporated into the analogue cheese composition may vary depending on the amounts of casein protein, whey protein cream, and/or other ingredients incorporated into the analogue cheese composition. When used, the amount of emulsifying salts may typically be within a range from 0.01 weight percent to 5 weight percent based on the total weight of the analogue cheese composition, such as from 0.05 weight percent to 3.0 weight percent.

In other examples, the analogue cheese composition containing whey protein cream can be formulated without using any emulsifying salts. In other words, the analogue cheese composition containing whey protein cream may be devoid of emulsifying salts. The whey protein cream may provide sufficient emulsification properties for the analogue cheese composition to eliminate the need for added emulsification salts.

Various other ingredients known in the food and cheese composition arts may be included in the analogue cheese composition. Such optional ingredients include an acidifying agent (e.g., vinegar, lactic acid, citric acid, acetic acid, and phosphoric acid), cream, milkfat, milk, salt, artificial coloring, spice, flavoring, mold-inhibitor, nutritional supplements, fiber (e.g., cellulose, oat fiber, etc.). The pH of the analogue cheese composition may be acidic (e.g., a pH less than 7.0), such as a pH less than 6.5. For example, the pH of the analogue cheese composition may range from 5.0 to 6.8, such as from 5.5 to 6.5.

The analogue cheese composition can exhibit good textural firmness for shredding, slicing, and/or otherwise being used by a food manufacturer and/or consumer. For example, the analogue cheese composition may exhibit a textual firmness of at least 400 g, such as at least 500 g, at least 600 g, at least 700 g, at least 800 g, at least 900 g, or at least 1000 g. For example, the analogue cheese composition may exhibit a textural firmness ranging from 500 g to 1250 g, such as from 600 g to 1000 g.

The analogue cheese composition can exhibit good melting properties. For example, the analogue cheese composition may exhibit a melt less than about 7 using the L.D. Schreiber melt test, such as a melt ranging from 2 to 7, from 3 to 7, or from 3 to 6.

The analogue cheese composition is generally prepared by combining and heating the constituent ingredients, including the whey protein cream, fat, water, hydrocolloid, casein protein, and/or other desired components to provide a homogenous mixture which is then cooled. Analogue cheese compositions containing whey protein cream according to the disclosure can exhibit exceptionally fast oil incorporation times, which can be beneficial for efficient, large scale manufacture of commercial analogue cheeses. Oil incorporate time is a measure of the amount of time it takes oil to incorporate into the other constituent ingredients of the cheese composition (e.g., the water and hydrophilic ingredients). The oil incorporation time can be measured from the time when oil is added to the remaining constituent ingredients of the cheese composition and mixing is started to the time when oil is no longer visually observable to the unaided eye as a separated ingredient (e.g., the oil appears visually to be fully incorporated into the mixture). In applications, the analogue cheese composition can exhibit an oil incorporation time during manufacture of less than 30 seconds, such as less than 25 seconds, less than 20 seconds, less than 15 seconds, or less than 10 seconds.

The analogue cheese composition of the present disclosure may be used as a standalone composition or may be combined with one or more other cheeses to provide a finished cheese composition for consumption and/or use. In some examples, the analogue cheese is combined with one or more dairy cheeses, e.g., to impart one or more cheese flavors to the finished product. The analogue cheese may be combined with the dairy cheese and a solid state, e.g., by mixing solid particles of the analogue cheese with solid particles of the dairy cheese. More typically, however, the dairy cheese may be incorporated into the analogue cheese during production when the analogue cheese is in a molten or liquidous state, thereby becoming compositionally dispersed throughout the analogue cheese to form a resultant cheese (e.g., pizza cheese) that is a homogeneous blend of the dairy cheese component and the analogue cheese component.

The dairy cheese used to formulate the cheese composition may be in the form of a soft cheese, a hard cheese, and/or a semi-hard cheese. In some examples, the dairy cheese is in the form of a cheese powder. Examples of one or more dairy cheeses that may be used in the cheese composition include, but are not limited to, mozzarella, Parmesan, cheddar, Monterey Jack, Romano, muenster, Swiss, provolone, and combinations thereof.

When used, the amount of dairy cheese utilized in the combined cheese composition (e.g., analogue cheese plus dairy cheese) may be at least 3 weight percent based on the total weight of the cheese composition, such as at least 5 weight percent, at least 7 weight percent, at least 8 weight percent, at least 9 weight percent, at least 10 weight percent, at least 11 weight percent, or at least 12 weight percent. For example, the amount of dairy cheese utilized in the combined cheese composition may range from 10.0 weight percent to 20 weight percent based on the total weight of the cheese composition, such as from 10.0 weight percent to 17 weight percent, or from 12 weight percent to 17 weight percent. The weight of the dairy cheese included in the combined cheese composition may be based on the natural cheese weight of the dairy cheese, including water present in the diary cheese. In other examples, the analogue cheese composition is provided as a dairy-free cheese and is not combined with a dairy cheese component.

Cheese compositions as described herein can be used as edible food products or can be further processed to form an edible food product. The cheese composition may be formed in a block and subsequently sized reduced by cutting slices, shredding, cubing, and/or performing other size reduction process. The cheese composition can be included as an ingredient or component of a food product that includes the cheese composition, such a pizza, pizza-type snack food, pizza roll, pizza pocket, “hot pockets,” sandwiches, hoagies, Italian foods such as lasagna and spaghetti, and the like, as well as cheese-stuffed foods such as jalapeno poppers. Example food product can include mozzarella substitute cheese compositions.

Cheese compositions and products can be combined with other food products before being packaged. Such cheese products can be incorporated or combined with other food products in any suitable way. For example, a final cheese product can be applied in any suitable form (e.g., shredded) to another food product such as pizza. As another example, a cheese can be injected in into a food product that includes cheese (e.g., snack food including pizza-type snack food and the like). A cheese composition can also be packaged, alone or in combination with other food ingredients, frozen, and stored for delayed use and consumption.

Any product containing a cheese according to the disclosure may be prepared, packaged, frozen, stored, and optionally shipped in a frozen state for commercial distribution and sale. The frozen food can be stored frozen for an extended period and eventually used by a private consumer or commercial user by heating the frozen food product (with optional thawing) in a conventional, convection, or microwave oven.

The following examples may provide additional details about cheese compositions containing whey protein cream and products according to the disclosure.

### EXAMPLES

### Example 1: Oil Incorporation Time

A variety of analog cheese compositions were formed that each included 52 wt % water, 21 wt % oil, 7.5 wt % protein, 16 wt % hydrocolloids, and 3.5 wt % of auxiliary components (salts, colorants, and preservatives). Different analogue cheese compositions tested as part of the example were identically formulated except for the use different protein sources in different samples and/or the use of fat-based emulsifiers (only in examples noted). Rennet casein was the protein source used in the Control sample. Rennet casein was also used as the protein source in the samples tested using different fat-based emulsifiers.

Each analogue cheese composition was made using a benchtop heated mixer. The constituent ingredients were mixed starting at 170F and heated to at least 179F during constant mixing over a 4-minute period in the blender. The time it took to visually observe the oil incorporate into the other constituent ingredients of the cheese was measured for each test variable. Measurement of the oil incorporation time started once all constituted ingredients were added to the mixer and the mixer was turned on. Measurement of the oil incorporation time ended as soon as oil was no longer observed as a separated component from the other constituent ingredients being mixed together.

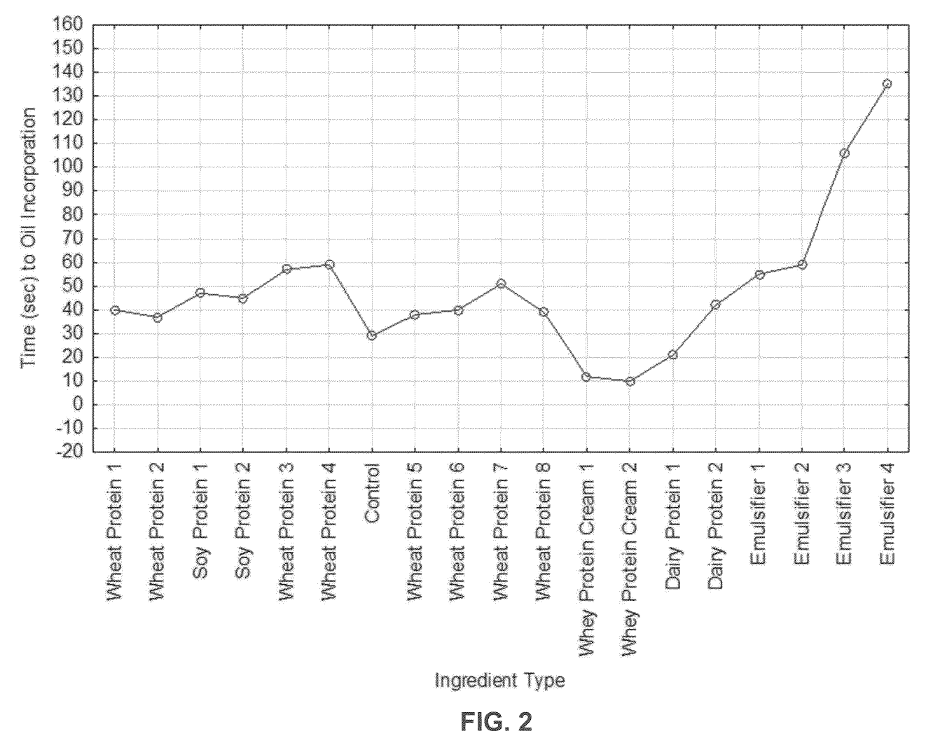

FIG. 2 is a chart illustrating oil incorporation times for the different analogue cheese samples tested as part of the example. The data show that the two samples containing whey protein cream exhibited a significant decrease, about 66%, in the amount of time it took to incorporate the oil versus control. The whey protein cream also incorporated oil significantly faster than the time it took the wheat and soy proteins to incorporate the oil.

Since whey protein cream also contains some naturally occurring phospholipids, other emulsifiers were tested for comparative purposes. These emulsifiers took just as long or longer than the tested proteins to incorporate the oil. This shows that the whey protein cream incorporated oil faster than protein or emulsifier into the cheese.

### Example 2: Cheese Texture

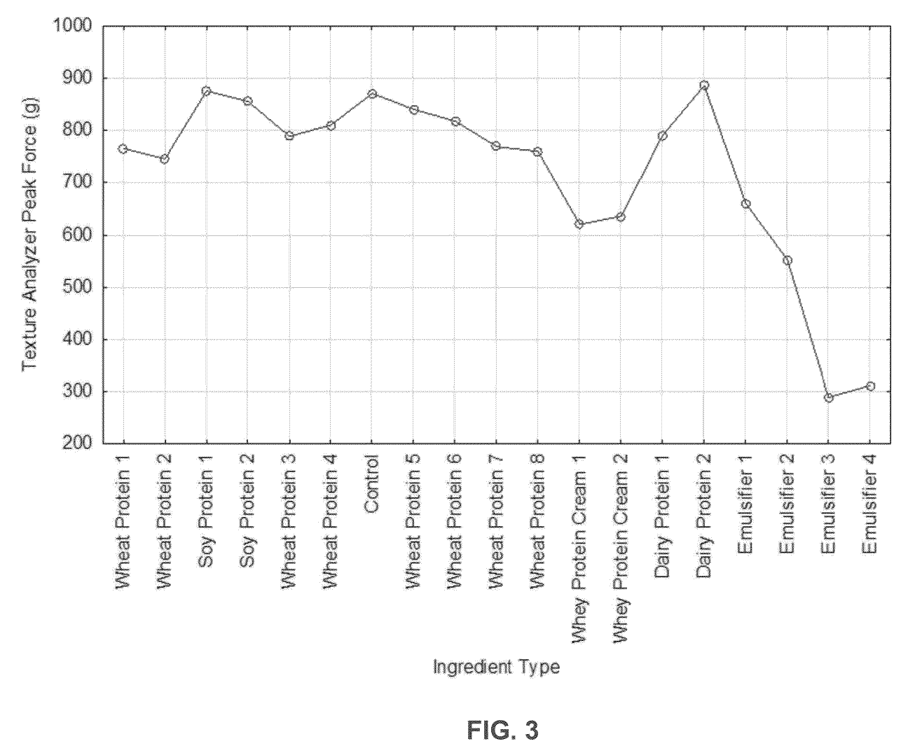

The texture of the different analogue cheese compositions formulated in Example 1 were tested to evaluate the textural firmness of the resulting cheese compositions, where textural firmness was measured as defined herein. FIG. 3 is a chart illustrating textural firmness measurements for the different analogue cheese compositions formulated according to Example 1.

The data show that the cheese samples made using whey protein cream had peak force firmness reading of 624 g and 630 g. This is a third lower than the peak force firmness reading of an analogue cheese that is produced using rennet casein. It is also significantly lower in force than all other samples produced using proteins from all sources. While the samples formulated using emulsifiers also lowered the firmness of the cheese, these emulsifier-containing samples produced particularly soft cheese. The firmness of the cheese helps to ensure the cheese can endure subsequent processing: dicing, shredding, slicing, etc.

1. A cheese composition comprising:
from 1.5 weight percent to less than 10 weight percent whey protein cream;
from 15 to 35 weight percent fat other than fat from the whey protein cream;
from 30 to 60 weight percent water; and
from 5 to 20 weight percent hydrocolloid.

2. The cheese composition of claim 1, further comprising less than 1.5 weight percent emulsifying salt.

3. The cheese composition of claim 1, further comprising casein protein in an amount not greater than 5 weight percent.

4. The cheese composition of claim 3, wherein all protein in the cheese composition is the casein protein and protein in the whey protein cream.

5. The cheese composition of claim 4, wherein a ratio of a weight of the whey protein cream divided by a weight of the casein protein ranges from 0.5 to 8.

6. The cheese composition of claim 1, wherein the hydrocolloid comprises a starch and a gum.

7. The cheese composition of claim 1, wherein a ratio of a weight of the fat divided by a weight of the whey protein cream is at least 4.

8. The cheese composition of claim 1, wherein all fat other than fat from the whey protein cream in the cheese composition is non-dairy fat.

9. The cheese composition of claim 1, comprising:
from 8 to 17 weight percent of the hydrocolloid;
from 0.05 to 3 weight percent of an emulsifying salt; and
from 2 to less than 9 weight percent of the whey protein cream.

10. The cheese composition of claim 1, wherein the cheese composition exhibits an oil incorporation time of less than 25 seconds.

11. The cheese composition of claim 1, wherein the cheese composition exhibits a textural firmness in a range from about 600 g force to about 1000 g force.

12. The cheese composition of claim 1, wherein the cheese composition has a pH within a range from about 5.5 to about 6.5.

13. The cheese composition of claim 1, wherein the cheese composition exhibits a melt test value less than about 7 using an L.D. Schreiber melt test.

14. The cheese composition of claim 1, wherein the whey protein cream comprises at least 10 weight percent fat and greater than 1 weight percent lactose.

15. A cheese composition comprising:
from 1 to less than 9 weight percent whey protein cream;
from 20 to 30 weight percent fat other than fat from the whey protein cream;
from 40 to 60 weight percent water;
from 10 to 17 weight percent hydrocolloid; and
from 1 to 12 weight percent casein protein.

16. The cheese composition of claim 15, further comprising from 0.05 to 3 weight percent emulsifying salt.

17. The cheese composition of claim 15, wherein:
the hydrocolloid comprises a starch and a gum, and the starch comprises at least 50 weight percent of the hydrocolloid in the cheese composition; and
a ratio of a weight of the fat divided by a weight of the whey protein cream is at least 4.

18. The cheese composition of claim 15, wherein the casein protein is present in the cheese composition in an amount not greater than 5 weight percent and all protein in the cheese composition is the casein protein and protein in the whey protein cream.

19. The cheese composition of claim 15, further comprising a non-casein, non-dairy protein.

20. The cheese composition of claim 15, wherein the whey protein cream comprises at least 10 weight percent fat and greater than 1 weight percent lactose.
